(19) United States
(12) Patent Application Publication
(10) Pub. No.: US 2024/0254908 A1
(43) Pub. Date: Aug. 1, 2024

(54) AQUEOUS COMPOSITION FOR THE TREATMENT OF EXHAUST GASES WITH IMPROVED ANTIFOAMING PROPERTIES

(71) Applicant: TotalEnergies OneTech, Courbevoie (FR)

(72) Inventors: Pierre DAVERAT, SAINT PRIEST (FR); Grégory FOULONNEAU, PARIS (FR); Véronica CASTILLO, SOLAIZE (FR); Frédéric TORT, GIVORS (FR)

(21) Appl. No.: 18/290,968

(22) PCT Filed: Jul. 19, 2022
(86) PCT No.: PCT/FR2022/051433

§ 371 Date: Jan. 22, 2024

(30) Foreign Application Priority Data
Jul. 23, 2021 (FR) FR2108013

(51) Int. Cl. F01N 3/20; B01D 53/94; C08G 77/46

(52) U.S. Cl. CPC F01N 3/2066; B01D 53/9418; C08G 77/46; B01D 2251/2067; B01D 2257/404; B01D 2258/012; F01N 2610/02

(57) ABSTRACT

The present invention relates to an aqueous composition comprising: —at least one reducing agent for nitrogen oxides and/or at least one precursor of such an agent, —at least one surfactant, and —at least one antifoaming additive chosen from copolymers comprising a polydimethylsiloxane backbone with a mean number of dimethylsiloxane units within the range of from 150 to 300, grafted by polyoxyalkylene chains. The present invention also relates to the use of such a composition for the treatment of exhaust gases at the outlet of internal combustion engines, and also to a method for treating the exhaust gases originating from an internal combustion engine using this composition.

The present invention relates to a composition for the treatment of exhaust gases at the outlet of on-board or stationary heat engines, whether the engines be engines for heavy vehicles such as heavy goods vehicles, transport vehicles, so-called off-road vehicles such as agricultural machinery, boats, or engines for light and/or commercial vehicles or engines for stationary industrial applications. It also relates to the use of such a composition in any device for treating exhaust gases, as well as a method for treating exhaust gases using this composition.

### PRIOR ART

European standards on pollution emitted by heat engines, in particular those supplied by fuels of the diesel type, in particular the standards applicable to heavy goods vehicles, have led the manufacturers of engines to install systems for the after-treatment of exhaust gases. These systems include SCR (selective catalytic reduction), EGR (exhaust gas recirculation), DOC (diesel oxidation catalyst), PF (particle filter) and SCRF® (SCR combined with a PF) technologies. These various after-treatment systems can be installed alone or in combination since they do not always act on the same pollutants present in the exhaust gases.

To comply with the standards, in particular the European ones (Euro IV et seq for heavy goods vehicles and Euro 6 for light vehicles), the majority of European manufacturers of motor vehicles have opted for SCR post-treatment at the exhaust of their engines. This post-treatment acts solely on reducing the nitrogen oxides present in the gases. Another advantage of this technique is that it affords, by optimised tunings of the engine, a substantial reduction in fuel consumption, in particular compared with other post-treatment systems such as NOx traps.

SCR post-treatment consists in reducing the nitrogen oxides NO and NO₂ (normally referred to as NOx) on a catalytic device that puts them in contact with a reducing agent. This device contains a catalyst comprising a carrier generally based on iron- and copper-exchanged zeolites. This catalyst favours the reduction of NOx into nitrogen, by reaction with the reducing agent. A conventional reducing agent is for example ammonia (NH₃). To introduce gaseous ammonia into the exhaust-gas treatment system, producing it directly in the pipe conveying these gases to the SCR system by vaporising an aqueous solution of a precursor of this reducing agent such as for example urea is known. The urea solution, injected at a mean exhaust temperature generally of 150 to 400° C., releases ammonia by virtue of successive thermolysis and hydrolysis reactions. Other ammonia-precursor compounds can be used under similar conditions. An injector is usually employed to introduce the aqueous solution of urea into the pipe conveying the exhaust gases to the SCR catalyst, upstream thereof. A mixer, installed between this injector and the SCR catalyst, can be used to improve vaporisation of the spray of aqueous solution of urea in the exhaust-gas flow. An example of a mixer is described in the document SAE 2015-01-1020 (“Advanced Close Coupled SCR Compact Mixer Architecture”, Michelin J. et al.).

Two conventional but non-limitative examples of configuration of the SCR post-treatment line are described below. The first, so-called “underfloor” configuration, consists in placing the SCR post-treatment device downstream of the engine, under the floor of the vehicle (generally at more than 50 cm to 1 m from the outlet of the combustion chamber). It has the advantage of being able to install the post-treatment device in a zone where a great deal of space is available and thus placing it under geometry conditions more favourable to vaporisation of the aqueous solution of urea. Another so-called “close-coupled” configuration consists in placing the SCR post-treatment device in the immediate vicinity of the engine (generally at less than 50 cm from the outlet of the combustion chamber). Compared with the so-called underfloor configuration, this configuration has the advantage of benefiting from higher temperatures in the SCR catalyst, improving the priming and efficacy thereof. On the other hand, its drawback is that the space available is less than in underfloor configuration, which means that the injector for aqueous solution of urea is placed closer to the mixer and to the SCR catalyst. This configuration can lead to less good vaporisation of the aqueous solution of urea. The documents SAE 2014-01-1522 (“Control of a Combined SCR on Filter and Under-Floor SCR System for Low Emission Passenger Cars”, Balland J. et al.) and SAE 2015-01-0994 (“Next Generation All in One Close-Coupled Urea-SCR System”, Kojima H. et al.), or WO 2014/060987 A1 describe these two types of configuration.

In some installation configurations of the SCR device and of the ammonia-precursor injection, in particular in the case of the injection of urea, manufacturers have noted the appearance of deposits in the exhaust pipes located between the injector and the SCR device. These deposits may be sufficiently great to cause partial or even complete blocking of the exhaust pipe related to the exhaust backpressure and thus to create engine power losses. At constant injection configuration, the quantity of deposits formed is greater at low temperatures than at high temperatures. These deposits, according to the analyses that were made in the technical publication SAE 2016-01-2327, are of variable natures according to the temperature at which they were formed. Thus, at temperatures below 250-300° C., they mainly consist of crystallised urea, and mainly consist of cyanuric acid above 300° C. Cyanuric acid can sublimate and once again produce gaseous ammonia. However, this reaction can occur only at a very high temperature, above 450° C. Such a temperature is rarely reached at this point in exhaust pipes.

It was found in particular that these deposits were present in the pipes having elbows because of the lack of space in the vehicle and when the distance separating the injection of urea and the first elbow is too short, as in the close-coupled configurations described above. The hypothesis formulated is that, in this type of configuration, some of the drops of urea do not have time to vaporise and to completely decompose into gaseous ammonia. The drops of urea are deposited on the wall of the pipe, which is at too low a temperature to allow complete decomposition into gaseous ammonia, and they decompose only partially, forming deposits of cyanuric acid stuck to the wall. Moreover, it was also found that, depending on the configuration of the SCR line and the temperature, the urea was liable to crystallise in the line, resulting in an obstruction of the line (see document SAE 2017-26-0132 (“A Study on the Factors Affecting the Formation of Urea Crystals and Its Mitigation for SCR After-Treatment Systems”, Jain A. et al.).

The application WO 2008/125745 describes an aqueous solution comprising a compound liable to release gaseous ammonia above 200° C. and at least one multifunctional additive the HLB of which varies from 7 to 17 to limit the formation of deposits based on cyanuric acid in a device for after-treatment of exhaust gases, in particular of the SCR type. The multifunctional additives used are in particular ethers of polyalkoxylated fatty alcohols and esters of polyalkoxylated fatty alcohols.

The application EP 2337625 describes a mixture of surfactants for reducing the diameter of the droplets of an aqueous solution of urea, and thus favouring vaporisation thereof and transformation of the urea into gaseous ammonia in an SCR system. The solution proposed consists of a mixture of polyalkoxylated fatty alcohols with controlled degrees of alkoxylation.

The application EP 2488283 describes additives for a urea solution, of the type consisting of particular polyalkoxylated fatty alcohols. These additives are also intended to favour a reduction in the formation of deposits resulting from the decomposition of urea in SCR systems.

The U.S. Pat. No. 5,453,257 teaches reducing the nitrogen oxide content in effluents from combustion of a carbon fuel by introducing into said effluents an emulsion of a compound reducing nitrogen oxides and a hydrocarbon compound having a boiling point below that of the agent reducing nitrogen oxides.

However, it has been found that aqueous solutions of ammonia precursor containing surfactants have a tendency to foam. This foaming occurs in particular during transport and handling of the solution, for example when it is discharged into storage vessels, and then when the composition is introduced from a storage vessel into the reservoir of a vehicle, which complicates the operation of filling the reservoir and can cause it to overflow. The normal use of nozzles for dispensing the composition also favours foaming thereof. Furthermore, foaming of the composition when it occurs at the time it is injected into the exhaust gas treatment system of the vehicle may cause the introduction of a greater or lesser quantity of air into said system. This phenomenon interferes with the control of the quantity of solution injected and affects the efficacy of the treatment system.

One solution to this problem consists in adding one or more antifoaming agents to the aqueous solution. However, such additives often represent an efficacy that decreases in the course of the storage time of the composition before use thereof, all the more quickly when the composition is stored at relatively high temperatures, above 30° C. or even 35 or 40° C. Under such storage conditions, the composition cannot generally be stored for more than a few months (on average 5 months), which proves to be very constraining.

There therefore remains a need to be able to formulate compositions for treating exhaust gases in the form of aqueous solutions based on a reducing agent for NOx, for example ammonia, or on a precursor of such a reducing agent, such as urea, which have optimised properties. It is expected of this composition that it be capable of preventing or reducing deposits during use of an SCR line, while avoiding foaming problems. It is also expected of this composition that it be stable over time, i.e. keeping its properties over long storage periods, including at high temperature.

The Applicant found that this objective was achieved by adding to the aqueous composition at least one particular additive consisting of one or more copolymers consisting of grafted polydimethylsiloxanes as defined below.

The object of the present invention is thus an aqueous composition comprising:
at least one agent reducing nitrogen oxides NOx and/or at least one precursor of such an agent,
at least one surfactant, and
at least one antifoaming additive selected from copolymers comprising a polydimethylsiloxane backbone with a mean number of dimethylsiloxane units in the range from 150 to 300, grafted by polyoxyalkylene chains.

Another object of the present invention is the use of such a composition for treating exhaust gases at the outlet of onboard or stationary internal combustion engines, more particularly for treating exhaust gases in a device for the selective catalytic reduction of nitrogen oxides.

The engine can in particular be selected from diesel engines, control-ignition engines (including petrol engines and VNG or vehicle natural gas engines), and dual fuel engines, in particular diesel-gas. Preferably, the engine is a diesel engine.

The present invention applies to any type of engine liable to emit nitrogen oxides, including onboard engines and stationary engines. The invention applies, among other things, to marine engines, heavy goods vehicle engines, engines of transport vehicles and of construction site machinery or agricultural machinery such as for example tractors, and to engines of light and commercial vehicles, as well as to engines used in stationary industrial applications.

Device for selective catalytic reduction of nitrogen oxides designates a device known per se under the name SCR device, standing for Selective Catalytic Reduction. Such a device comprises a selective catalytic reduction catalyst (also referred to as SCR catalyst).

The invention also relates to a method for treating exhaust gases coming from an internal combustion engine, preferably a diesel engine, equipped with a device for selective catalytic reduction of nitrogen oxides, this method being characterised in that it includes at least one step of introducing a composition as defined above into the pipe that conveys the exhaust gases from the outlet of the engine to said selective catalytic reduction device.

Hereinafter, SCR exhaust line or SCR line, in a manner known per se, designates the pipe that conveys the exhaust gases from the outlet of an engine to a selective catalytic reduction device (SCR device).

The composition according to the invention has numerous advantages: it can be used in the same way and in the same equipment as the solutions of the prior art. It is at least as effective, or even more effective, than the solutions of the prior art, in particular the solutions based on urea, in reducing or preventing the formation of deposits in SCR systems, in particular in so-called close-coupled configurations. It causes no or very little foaming during handling, use, transfer and/or transport thereof, for example during decanting operations or operations of filling containers such as drums, vehicle reservoirs, storage vessels and transport vessels. It makes it possible in particular to avoid overflowing during filling of the storage reservoir of a vehicle. It also makes it possible to fill storage vessels and reservoirs of vehicles more quickly, and in the latter case limiting the spurts of filling nozzles.

This composition furthermore affords precise control of the quantity of composition injected and makes it possible in particular to avoid errors related to the falsifying of sensors by the foam.

The composition according to the invention is stable in storage. It also has antifoaming performances maintained over time, in particular over periods that may range up to one year, over a wide range of storage temperatures, ranging from 5° C. to 40° C.

Other objects, features, aspects and advantages of the invention will appear even more clearly upon reading the following description and examples.

Hereinafter, and unless stated otherwise, the bounds of a range of values are included within this range, in particular in the expressions “lying between” and “ranging from . . . to . . . ”.

Moreover, the expressions “at least one” and “at least” used in the present description are respectively equivalent to the expressions “one or more” and “higher than or equal to”.

Finally, as is known per se, a C_{N} compound or group means a compound or a group containing N carbon atoms in its chemical structure.

### DETAILED DESCRIPTION

The Reducing Agent and/or the Precursor of Such an Agent

The composition used in the invention comprises at least one agent reducing nitrogen oxides NOx and/or at least one precursor of an agent reducing nitrogen oxides.

“Agent reducing nitrogen oxides” means a compound capable of at least partially, if not completely, reducing nitrogen oxides (also referred to as NOx to designate the compounds NO and NO₂) to nitrogen, under the conventional operating conditions of an SCR line, i.e. in the presence of an SCR catalyst and at a temperature ranging from 150 to 400° C. Among the agents reducing NOx, ammonia (NH₃) can in particular be cited.

“Precursor of an agent reducing NOx” means a compound able to release an agent reducing NOx under the effect of temperature and/or by catalytic reaction.

Among ammonia precursors, mention can be made of urea which, by successive thermolysis and hydrolysis reactions, produces ammonia in accordance with a well known method. The SCR exhaust line can comprise, upstream of the SCR catalytic system, a catalyst the function of which is to transform a precursor of an agent reducing NOx, in particular into gaseous ammonia.

Preferably, the reducing agent or the precursor of the reducing agent is selected from the list consisting of urea, ammonia, formamide, ammonium salts, in particular ammonium formiate and ammonium carbamate, and guanidine salts, in particular guanidinium formiate; and preferably from the list consisting of urea and ammonia.

According to a preferred embodiment, urea is used, which is a reducing-agent precursor. This is because urea has the advantage of being stable, non-volatile, non-explosive and nonflammable. It can be transported without risk, and stored and handled by an operator without any specific training.

In this embodiment, the composition has a urea content preferably ranging from 25% to 42% by weight, more preferentially from 30% to 40% by weight, even more preferentially from 31 to 35% by weight and better still from 32% to 33% by weight, with respect to the total weight of the composition. Particularly preferably, the composition contains urea in a proportion of 32.5±0.7% by weight, in accordance with the specifications of ISO 22241-1.

According to a particularly preferred variant of this embodiment, the aqueous solution according to the invention is prepared from the commercial product AdBlue®, which is an aqueous solution of urea at 32.5±0.7% by weight. The term AdBlue® is used in the present description to designate indifferently the commercial products well known by the following names: AdBlue®, DEF, AUS32, ARLA32. By extension, this name is intended to mean all the products in the AdBlue® range, including the product marketed under the name AUS40, which corresponds to an aqueous solution of urea at approximately 40% by weight and is mainly intended for marine engines.

However, using aqueous compositions containing urea with a concentration above 32.5%, which can then be diluted just before use, also falls within the scope of the present invention. This variant makes it possible to make savings during transport of these urea-based compositions.

### Surfactants

The composition used in the invention comprises one or more surfactants, which can in particular be selected from ionic, non-ionic or amphoteric surfactants, soluble in water.

Ionic surfactants can be selected from cationic surfactants and anionic surfactants, and preferably from cationic surfactants. The latter generally comprise a nitrogen group that is cationic or ionisable in cationic form. They can in particular be selected from linear alkylammonium and alkylamines, linear diamines, aromatic or saturated heterocycles containing one or more nitrogen atoms, cyclic compounds of the imidazole type, etheramines and etheramides, oxyamines and ethoxyamines, taken alone or in a mixture.

Amphoteric surfactants can in particular be selected from amino acids and the imide or amide derivatives thereof, taken alone or in a mixture.

Non-ionic surfactants are preferably selected from the following compounds:
a) hydrocarbyl and mono- or polyalkylene glycol ethers,
b) hydrocarbyl and polyol ethers,
c) fatty acid and mono- or polyalkylene glycol esters,
d) fatty acid and mono- or polyglycerol esters,
e) and mixtures of these compounds.

“Hydrocarbyl” means a group selected from an alkyl, an alkenyl, an alkynyl, an aryl, an aryl-alkyl or “aralkyl”; advantageously the hydrocarbyl is a C₁-C₅₀ group.

“Cᵢ-Cⱼ alkyl” means a saturated, linear, branched or cyclic hydrocarbon chain comprising from i to j carbon atoms.

“Cₓ-C_{y} alkenyl” means a linear, branched or cyclic hydrocarbon chain including at least one double carbon-carbon bond, and comprising x to y carbon atoms.

“Cₓ-C_{y} alkynyl” means a linear, branched or cyclic hydrocarbon chain including at least one triple carbon-carbon bond, and comprising x to y carbon atoms.

“Cₓ-C_{y} aryl means a functional group that derives from an aromatic hydrocarbon compound comprising from x to y carbon atoms. This functional group may be monocyclic or polycyclic. By way of illustration, a C₆-C₁₈ aryl may be phenyl, naphthalene, anthracene, phenanthrene and tetracene.

“Cₓ-C_{y} aralkyl” means an aromatic hydrocarbon compound, preferably monocyclic, substituted by at least one linear or branched alkyl chain and where the total number of carbon atoms of the aromatic ring and of its substituents ranges from x to y carbon atoms. By way of illustration, a C₇-C₁₈ aralkyl can be selected from the group formed by benzyl, tolyl and xylyl.

Polyol means, within the meaning of the present invention, an oxygenated hydrocarbon compound comprising at least two alcohol functions. The polyols can optionally contain one or more other oxygenated functions, such as for example an acetal function, an ether bridge or an ester group.

Fatty acid means, in a manner known per se, a carboxylic acid comprising a C₄-C₃₀ linear or branched alkyl or alkenyl chain, preferably C₈-C₃₀.

### a) Hydrocarbyl and Mono- or Polyalkylene Glycol Ethers

Hydrocarbyl and mono- or polyalkylene glycol ethers can be monoethers or diethers, depending on whether the polyalkylene glycol chain is substituted on one or two ends by a hydrocarbyl group.

The hydrocarbyl and mono- or polyalkylene glycol ethers are advantageously selected from those comprising a C₁-C₅₀ hydrocarbyl group and from 1 to 60 alkylene glycol units.

The hydrocarbyl and mono- or polyalkylene glycol ethers are more preferentially selected from the following compounds:
the mono- or polyalkoxylated hydrocarbyl monoethers of formula (I): R—(Y)ₙ—OH;
the mono- or polyalkoxylated hydrocarbyl diethers of formula (II): R—(Y)ₘ—OR′;
the mono- or polyalkoxylated hydrocarbyl diethers of formula (III): HO—(Y)ₙ—R″—(Y′)ₘ—OH;
and mixtures of these compounds.

In the above formulae (I) to (III), R and R′ independently represent C₃-C₄₀ alkyl or alkenyl or alkynyl or aryl or aralkyl groups; R″ represents an alkane diyl or alkene diyl or alkyne diyl or a C₃-C₄₀ aryl diradical or aralkyl diradical.

To facilitate the description, hereinafter the same designation of alkyl or alkenyl or alkynyl or aryl or aralkyl radical will be used for a monoradical (R, R′) and for a diradical (R″).

In the above formulae (I) to (III), Y and Y′ are groups selected independently of each other from the following groups: —(O—CH₂—CH₂)—, —(O—CH(CH₃)—CH₂)— and —(O—CH₂—CH₂—CH₂)—.

In one and the same compound of formula (I), (II) or (III), the Y and respectively Y′ groups may be all identical or may be different. For example, —(Y)ₙ— may represent a copolymer with ethylene oxide and propylene oxide units, such as for example a block copolymer.

Preferably, in the formulae (I) to (III), the Y and respectively Y′ groups are all identical.

Also preferably, in the formulae (I) to (III), the groups Y and respectively Y′ are all ethylene oxide of formula —(O—CH₂—CH₂)—.

In the above formulae (I) to (III), n, m represent the degree of alkoxylation of the molecule, and designate independently of each other an integer ranging from 1 to 60, advantageously from 1 to 30, even better from 1 to 20. More preferentially, n and m vary from 3 to 15, even better from 5 to 12.

Advantageously, in formula (III), the Y and Y′ groups represent —(O—CH₂—CH₂)— and n=m.

According to a first embodiment, in the formulae (I), (II) and (III), advantageously R, R′ and R″ are selected from the alkyl and alkenyl groups, linear or branched, preferably linear.

Even more advantageously, R, R′ and R″ are selected from the C₅-C₃₂ groups, more preferentially C₈-C₃₀.

The compounds of formula (I) can be particularly selected from polyalkoxylated linear or branched fatty alcohols comprising from 4 to 30 carbon atoms, preferably 8 to 30 carbon atoms, better 10 to 24 carbon atoms; and from 5 to 12 ethylene oxide and/or propylene oxide units, preferably ethylene oxide.

Among the compounds of formula (I) available commercially, mention can be made of the products in the Marlipal® range and those in the Surfaline® range.

According to a second embodiment, in the formulae (I), (II) and (III), R, R′ and R″ are selected from the C₄-C₅₀ alkynyls.

Advantageously, this embodiment relates to formula (III), wherein R″ is a C₄-C₅₀ alkynyl.

For example, according to this embodiment, the compound of formula (III) can be represented by the following formula (IV):

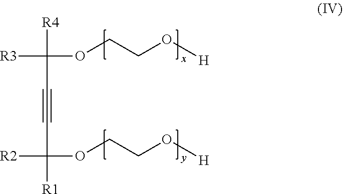

wherein R1, R2, R3, R4 represent independently of one another H or a C₁-C₂₀ alkyl group and x and y represent independently of each other an integer ranging from 1 to 60, preferably from 1 to 30.

One example of a commercial products complying with this formula is Surfynol 104® marketed by the company Air Products.

According to a third embodiment, in the formulae (I), (II) and (III), R, R′ and R″ are selected from the aralkyl groups comprising 9 to 30 carbon atoms.

Preferably, this embodiment relates to formula (I), wherein R represents a group selected from the aralkyls comprising from 9 to 30 carbon atoms.

More preferably, R is selected from the para-alkylphenyls comprising a C₁-C₂₄ alkyl group, more preferentially C₃-C₂₀, and even better C₅-C₁₈.

According to this embodiment, the compound of formula (I) can be represented by the following formula (V):

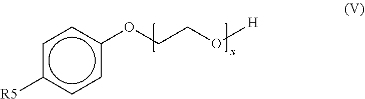

wherein R5 represents a C₁-C₂₄ alkyl group, preferably C₃-C₂₀, even better C₅-C₁₈, and x represents an integer ranging from 1 to 50, preferably from 1 to 30.

One example of such a compound is the product Dynol 800® marketed by the company Air Products, which complies with the following formula:

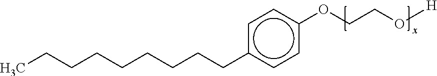

The compounds of formula (I) can advantageously be mixtures obtained by reacting R—OH alcohols with n units of ethylene oxide and/or propylene oxide, n represents the number of moles of alkylene oxide that are caused to react with one mole of R—OH alcohol.

The compounds of formula (II) can advantageously be mixtures obtained by reacting R—OH alcohol compounds with m ethylene oxide and/or propylene oxide units followed by an etherification reaction with an R′—OH alcohol compound. m represents the number of moles of alkylene oxide that are caused to react with one mole of R—OH alcohol.

The compounds of formula (III) can advantageously be obtained by reacting an HO—R″—OH diol with (n+m) units of ethylene oxide and/or propylene oxide. Advantageously, in formula (III): n=m. (m=n) represents the number of moles of alkylene oxide that are caused to react with one mole of HO—R″—OH diol.

The compounds of formula (I), (II) and (III) are generally in the form of mixtures of compounds having varied degrees of alkoxylation.

### b) Hydrocarbyl and Polyol Ethers,

The hydrocarbyl and polyol ethers are advantageously selected from the ethers originating from an alcohol including a C₁-C₅₀ alkyl or alkenyl group, preferably C₃-C₄₀, more advantageously C₅-C₃₂, even better C₈-C₃₀, and from a polyol.

The polyols referred to here are different from the mono- and polyalkylene glycols.

Advantageously, according to a first variant, the polyol is selected from the compounds belonging to the family of carbohydrates and oligomers thereof. In particular, the polyol is selected from cyclic carbohydrate compounds, such as for example oligomers of glucopyranose. The invention relates in particular to cyclic hydrocarbyl and polyglucoside ethers,

Among the cyclic hydrocarbyl and polyglucoside ethers, mention can be made of the alkyl polyglucosides such as the product marketed under the name Triton CG650® by the company Dow Chemical.

Advantageously, according to a second variant, the polyol is glycerol or an oligomer of glycerol, for example an oligomer comprising 2 to 30 glycerol units, preferably from 3 to 20 glycerol units.

### c) Fatty Acid and Mono- or Polyalkylene Glycol Esters

Fatty acid and mono- or polyalkylene glycol esters are molecules resulting from the condensation of at least one fatty acid with 1 to 60 alkylene glycol units, preferentially 1 to 50 alkylene glycol units. Advantageously, they originate from the reaction of a fatty acid with 1 to 50 ethylene glycol units.

Fatty acids are generally molecules comprising an alkyl or alkenyl chain, carrying at its end a carboxylic acid function, and comprising 4 to 30 carbon atoms, preferably 8 to 30 carbon atoms, more advantageously 8 to 24 carbon atoms.

The fatty acid group may be a single molecule or a mixture corresponding to the fatty-acid distribution of an animal or vegetable oil.

Among fatty acids, mention can be made non-limitatively of a saturated fatty acid such as n-caproic acid, caprylic acid, n-capric acid, lauric acid, myristic acid, palmitic acid, stearic acid, isostearic acid or arachidic acid or an unsaturated fatty acid such as palmitoleic acid, oleic acid, linoleic acid, linolenic acid, arachidonic acid or docosahexanoic acid.

The fatty acid and mono- or polyalkylene glycol esters advantageously comprise from 3 to 50, even better from 5 to 40 alkylene oxide units. Even better, the fatty acid esters and mono- or polyalkylene glycol esters comprise from 3 to 50, advantageously from 5 to 40 ethylene oxide units.

As examples of fatty acid esters and polyalkylene esters mention can be made of the product DUB S PEG 30S (PEG-30 stearate) marketed by the company Stéarinerie Dubois.

### d) Fatty Acid and Mono- or Polyglycerol Esters

Fatty acid and mono- or polyalkylene glycol esters are molecules resulting from the condensation of at least one fatty acid with 1 to 60 alkylene glycol units, preferentially 1 to 50 glycerol units.

The fatty acids are identical to those described at point c) above.

The fatty acid and mono- or polyglycerol esters advantageously comprise from 3 to 50, even better from 5 to 40 glycerol units.

As examples of fatty acid and polyglycerol esters mention can be made of the product Polyaldo 10-1-0 KFG® (polyglycerol laurate) marketed by the company Lonza.

According to a preferred embodiment, the surfactant or surfactants are selected from non-ionic surfactants. It is particularly preferred to use one or more surfactants selected from hydrocarbyl and mono- or polyalkylene glycol ethers, and more preferentially from mono- or polyalkoxylated hydrocarbyl monoethers of formula (I):

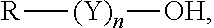

wherein
R represents a C₃-C₄₀ alkyl, alkenyl or alkynyl group, preferably C₈-C₃₀, even more preferentially C₁₀-C₂₄;
Y is selected from: —(O—CH₂—CH₂)—, —(O—CH(CH₃)—CH₂)— and —(O—CH₂—CH₂—CH₂)—; and preferably Y designates —(O—CH₂—CH₂)—;
n is an integer ranging from 1 to 60, preferably from 1 to 30, more preferentially from 1 to 20, better from 3 to 15, even better from 5 to 12.

The surfactant or surfactants are advantageously present in a total proportion ranging from 5 to 10,000 ppm by weight, preferably from 50 to 5000 ppm by weight, more preferentially from 100 to 2500 ppm by weight and better still from 200 to 1000 ppm by weight, with respect to the total weight of the composition.

### Antifoaming Additives

The composition used in the invention comprises one or more antifoaming additives selected from copolymers comprising a polydimethylsiloxane backbone with a mean number of dimethylsiloxane units in the range from 150 to 300, grafted by polyoxyalkylene chains.

These copolymers are therefore grafted polymers, with a polydimethylsiloxane backbone and polyoxyalkylene side chains (or grafts) grafted onto the backbone.

The backbone of these polymers consists of a polydimethylsiloxane chain (also usually referred to as PDMS), i.e. a chain of formula —[Si(CH₃)₂—O]ₙ—, with n a number lying in the range from 150 to 300.

Preferably, the polydimethylsiloxane backbone comprises a mean number of dimethylsiloxane units lying in the range from 180 to 250. This corresponds to a value of the number n lying in the range from 180 to 250.

The polyoxyalkylene chains advantageously comply with the formula —(RO)ₘ— with R designating one or more C₁ to C₄ alkylene groups, branched or linear, preferably C₂ or C₃, and m a number lying in the range from 10 to 55.

Preferably, the mean number m of oxyalkylene units lies in the range from 20 to 50, more preferentially from 30 to 50.

Also preferably, R designates one or more C₂ and/or C₃ alkylene groups, and more preferably the polyoxyalkylene chains are selected from the polyoxyethylenes (EO) of formula —(CH₂—CH₂—O)ₘ—, the polyoxypropylenes (PO) of formula —(CH₂—CH(CH₂)—O)ₘ—, and the chains formed by oxyethylene units and oxypropylene units (EO/PO).

According to a particularly preferred embodiment, the polyoxyalkylene chains are formed by oxyethylene (EO) units and oxypropylene (PO) units. Preferably, the ratio of the mean number of EO units to the mean number of PO units lies in the range from 0.2 to 2, preferably from 0.3 to 1.3. Preferably, these chains are formed by polyoxyethylene blocks and polyoxypropylene blocks.

The grafting rate of the copolymers (i.e. the mean number proportion of dimethylsiloxane units carrying a polyoxyalkylene side chain) advantageously lies in the range from 0.5% to 5%, preferably from 1% to 2%.

Unless expressly indicated to the contrary, all the means mentioned in the present description are number means.

According to a preferred embodiment, the copolymers constituting the antifoaming additive are cross-linked. Such cross-linking confers a three-dimensional structure thereon.

The antifoaming additive or additives are advantageously present in a total proportion ranging from 1 to 200 ppm by weight, preferably from 2 to 100 ppm by weight, more preferentially from 3 to 50 ppm by weight, better from 4 to 25 ppm by weight and better still from 5 to 15 ppm by weight, with respect to the total weight of the composition.

The copolymers described above are known per se and are commercially available.

In the commercial products, these copolymers may in particular be in diluted form, in a mixture containing same.

In this case, the proportion of copolymer or copolymers of such mixtures is generally in the range from 10 to 80% by weight, preferably from 20 to 60% by weight, more preferentially from 30 to 50% by weight and better still from 35 to 45% by weight.

Thus, according to one embodiment, the antifoaming additive or additives are used in a mixture with an inorganic oxide, such as for example solid hydrophobic silica.

According to another embodiment, the antifoaming additive or additives are used in a mixture with one or more emulsifying agents, which may in particular be selected from the polyoxyalkylene polymers as described above, and more preferentially EO/PO copolymers. These polymers generally originate from the synthesis of the copolymer and correspond to a proportion of polyoxyalkylene chains not grafted onto the polydimethylsiloxane backbone.

According to a particularly preferred embodiment, the antifoaming additive or additives are used in a mixture with an inorganic oxide and an emulsifying agent, such as in particular with hydrophobic silica and one or more polyoxyalkylene polymer or polymers as described above.

The products containing the antifoaming additive or additives may be in the form of a solid product, in particular anhydrous (i.e. devoid of water), or in the form of solution in a solvent that may be water or an organic solvent.

### The Other Constituents

The aqueous composition may optionally contain one or more other compounds, different from the reducing agents for nitrogen oxides and precursors thereof, surfactants and antifoaming additives described above.

The composition can thus comprise, non-limitatively, one or more organic fluids miscible or not with water, such as for example alcohols, polyols, paraffinic fluids, and/or one or more metallic compounds.

### The Composition and Methods for Producing Same

The composition used in the present invention is an aqueous composition, i.e. the main component thereof is water. The water content of the composition preferably lies in the range from 50 to 90 by weight, preferably from 60 to 80 by weight, and better still from 65 to 70% by weight, with respect to the total weight of the composition.

The composition can be prepared in the usual manner by mixing the constituents thereof, preferably at ambient tablature, typically in a temperature range in general from 10 to 60° C.

According to a preferred production method, the aqueous composition is prepared from a pre-formulated aqueous solution of urea, such as for example a commercial composition known by the name AdBlue® comprising 32.5% by weight urea.

A first production method consists in adding the surfactant or surfactants and the antifoaming additive or additives to this pre-formulated aqueous solution of urea, in quantities required for achieving the proportions defined above.

A second production method consists in adding, to this pre-formulated aqueous solution of urea, a concentrated aqueous composition of urea with additives. According to this production method, the concentrated aqueous composition of urea with additives comprises the surfactant or surfactants and the antifoaming additive or additives in proportions very much greater than that of the final aqueous composition introduced into the SCR line, in an aqueous solution of urea, preferably at a proportion of 32.5% by weight urea. The mixing of the two compositions in an appropriate ratio for obtaining the required final proportions is implemented just before the injection into the SCR line.

The same production methods can be implemented using a pre-formulated aqueous solution of a precursor other than urea.

### Use

The aqueous composition according to the invention is used for treating the exhaust gases discharged from an internal combustion engine in a device for the selective catalytic reduction of nitrogen oxides or SCR device.

For this purpose, it is introduced into the SCR exhaust line, downstream of the engine and upstream of the SCR device. This introduction is typically implemented by pumping the composition from one or more reservoirs and injecting it by means of one or more injectors, which atomise the composition in the flow of exhaust gases. These devices are known per se.

The use according to the invention also makes it possible to prevent or reduce deposits in the pipe that conveys the exhaust gases from the outlet of an internal combustion engine towards said selective catalytic reduction device.

These deposits are typically deposits of nitrogen compounds, containing the agent or agents for reducing the nitrogen oxides and/or the precursor or precursors thereof, and/or decomposition products of said precursors. The invention particularly makes it possible to prevent and/or reduce deposits of urea and/or of cyanuric acid, and more particularly deposits of cyanuric acid in the SCR exhaust pipe.

As indicated above, the invention makes it possible to reduce or prevent these deposits whatever the conformation of the SCR line. The invention is particularly, but non-limitatively, adapted for so-called “close-coupled” and “underfloor” SCR exhaust lines as described above.

In particular, the invention makes it possible to reduce such deposits, while preventing phenomena of foaming of the composition.

As disclosed above, the composition injected into the SCR line is pumped from one or more conventional storage reservoirs, known per se.

According to a first variant, all the components of the composition according to the invention, in particular the agent or agents for reducing nitrogen oxides and/or precursor or precursors thereof, the surfactant or surfactants and the antifoaming additive or additives are formulated in one and the same aqueous composition in the required proportions, and this composition is introduced into a single reservoir.

According to a second variant, a first intermediate aqueous composition is formulated, comprising the agent or agents for reducing nitrogen oxides and/or the precursor or precursors thereof, in the required proportions in the final composition resulting from the mixing of the two intermediate compositions. This first intermediate composition is introduced into a first reservoir. A second concentrated intermediate aqueous composition with additives is formulated, comprising the agent or agents for reducing nitrogen oxides and/or the precursor or precursors thereof, in the required proportions in the final composition resulting from the mixing of the two intermediate compositions, as well as the surfactant or surfactants and the antifoaming additive or additives in a more concentrated proportion than the required proportion in said final composition.

This second composition is introduced into a second reservoir, distinct from the first reservoir. The two reservoirs supply the same injection system, enabling the two intermediate compositions to be mixed. A vehicle comprising two reservoirs for implementing such a variant is described in particular in EP2541012.

### The Method

The process (or method) according to the invention makes it possible to treat the exhaust gases originating from an internal combustion engine, preferably a diesel engine, equipped with an SCR system.

This method comprises a step of introducing an aqueous composition as described above into the pipe conveying the exhaust gases discharged from an engine to a device for the selective catalytic reduction of nitrogen oxides. This introduction is typically implemented by pumping the composition from one or more reservoirs and injecting it into said pipe by means of one or more injectors, as described above.

The following examples are given by way of illustration of the invention, and should not be interpreted so as to limit the scope thereof.

### Examples

### Compositions Tested:

As a base composition use is made of a commercial aqueous solution at 32.5% by weight AdBlue® urea, complying with ISO 22241, to which there has been added 500 ppm by weight of a surfactant consisting of a mixture of polyethoxylated fatty alcohols, commercially available from the company Arkema under the name Surfalinex® 1308L at 85% by weight active material. These polyethoxylated fatty alcohols are polyoxyethylenated hydrocarbyl monoethers complying with formula (I) defined above, and comprising between 1 and 20 units derived from ethylene glycol and the hydrocarbyl group of which is a C₈-C₃₀ alkyl group. 500 ppm of the commercial product Surfaline® 1308L was used for each composition, which corresponds to a surfactant content of 425 ppm by weight.

This base composition comprising the urea and surfactant is called C0.

The various antifoaming additives A1 to A4 defined below were added to the base composition C0, to obtain the respective compositions C₁ to C₄:
A1 (comparative): antifoaming additive in the form of cross-linked siloxane emulsion in water, marketed under the name Foam Ban®MS-525 by the company Münzing;
A2: cross-linked copolymer comprising a PDMS backbone with a mean number of dimethylsiloxane units of 195, grafted by chains formed by polyoxyethylene blocks and polyoxypropylene blocks having a mean number of OE units=9 and a mean number of OP units=23; grafting rate 1.76%; this copolymer is in the form of a mixture also containing hydrophobic silica and OE/OP copolymers, the mixture containing 40% by weight said copolymer;
A3: cross-linked copolymer comprising a PDMS backbone with a mean number of dimethylsiloxane units of 230, grafted by chains formed by polyoxyethylene blocks and polyoxypropylene blocks having a mean number of OE units=21 and a mean number of OP units=18; grafting rate 1.41%; this copolymer is in the form of a mixture also containing hydrophobic silica and OE/OP copolymers, the mixture containing 40% by weight said copolymer;
A4: cross-linked copolymer comprising a PDMS backbone with a mean number of dimethylsiloxane units of 200, grafted by chains formed by polyoxyethylene blocks and polyoxypropylene blocks having a mean number of OE units=16 and a mean number of OP units=30; grafting rate 1.57%; this copolymer is in the form of a mixture also containing hydrophobic silica and OE/OP copolymers, the mixture containing 40% by weight said copolymer.

The proportions of each antifoaming additive in the compositions tested are set out in table 1 below, with RM meaning raw material and AM active material:

TABLE 1

| Composition | Antifoaming additive | Proportion | |
|---|---|---|---|
| C0 (comparative) | — | — | |
| C1 (comparative) | A1 | 25 | ppm RM⁽¹⁾ |
| C2 (invention) | A2 | 5 | ppm AM |
| C3 (invention) | A3 | 5 | ppm AM |
| C4 (invention) | A4 | 5 | ppm AM |

⁽¹⁾The composition C1 contains 25 ppm by weight the commercial product Foam Ban ®MS-525.

### Test Method

The foaming level of these various compositions was determined by means of a DFA100 foaming bench marketed by the company Krüss.

In this system, the foaming is generated by adding ascending air, introduced through a sintered glass located at the bottom of a column containing the composition to be tested. The device allows direct reading of the volume of foam formed as a function of time.

The measurements were made each time after a duration of injection of air of 30 s, at a rate of 0.3 L/min. The volume of composition introduced into the column for each test is 40 ml. The volumes of foam were measured 600 s after the start of the test.

Each composition was tested immediately after preparation thereof (results at T₀), and then after storage for a period of 12 months (results at T₁₂) at various temperatures: ambient temperature AT (25° C.), 8° C. and 40° C.

### Results

The results obtained are detailed in Tables 2 and 3 hereinbelow.

TABLE 2

| | Volume of | Volume of foam at T₁₂ | |
|---|---|---|---|
| Composition | foam at T₀ | Storage at AT | |
| C0 (comparative) | 70 ml | 100 | ml |
| C1 (comparative) | 18 ml | 95 | ml |
| C2 (invention) | 13 ml | 20 | ml |
| C3 (invention) | 12 ml | 20 | ml |
| C4 (invention) | 10 ml | 27 | ml |

TABLE 3

| | Volume of foam at T₁₂ - | | Volume of foam at T₁₂ - | |
|---|---|---|---|---|
| Composition | storage at 8° C. | | storage at 40° C. | |
| C0 (comparative) | 113 | ml | 134 | ml |
| C1 (comparative) | 66 | ml | 121 | ml |
| C2 (invention) | 30 | ml | 80 | ml |
| C3 (invention) | 28 | ml | 50 | ml |

| | | | |
|---|---|---|---|
| C4 (invention) | 34 | ml | Not performed |

The above results show that compositions C2 to C4 according to the invention have a foaming level very much less than that of composition C0 not comprising the antifoaming additive, and less than composition C1 comprising a comparative antifoaming additive at a higher treatment level.

The performances of the three compositions according to the invention remain superior to those of the comparative compositions after one year of storage, both at ambient temperature and at low (8° C.) or high)(40° C. temperatures.

1. An aqueous composition comprising:
at least one agent reducing nitrogen oxides and/or at least one precursor of such an agent,
at least one surfactant, and
at least one antifoaming additive selected from copolymers comprising a polydimethylsiloxane backbone with a mean number of dimethylsiloxane units in the range from 150 to 300, grafted by polyoxyalkylene chains.

2. The composition according to the preceding claim, characterised in that the reducing agent or the precursor of the reducing agent is selected from the list consisting of urea, ammonia, formamide, ammonium salts, and guanidine salts; and more preferentially the reducing-agent precursor is urea.

3. The composition according to claim 1, characterised in that the composition contains urea, in a proportion ranging from 25% to 42% by weight, preferably from 30% to 40% by weight, more preferentially from 31 to 35% by weight and better still from 32% to 33% by weight, with respect to the total weight of the composition; and more preferentially still of 32.5±0.7% by weight, with respect to the total weight of the composition.

4. The composition according to claim 1, characterised in that the surfactant or surfactants are selected from ionic, non-ionic or amphoteric surfactants, soluble in water; and preferably from non-ionic surfactants selected from the following compounds:
a) hydrocarbyl and mono- or polyalkylene glycol ethers,
b) hydrocarbyl and polyol ethers,
c) fatty acid and mono- or polyalkylene glycol esters,
d) fatty acid and mono- or polyglycerol esters, and
e) mixtures of these compounds.

5. The composition according to the preceding claim, characterised in that the surfactant or surfactants are selected from the mono- or polyalkoxylated hydrocarbyl monoethers of formula (I):
R—(Y)ₙ—OH, wherein:
R represents a C3-C40 alkyl, alkenyl or alkynyl group, preferably C8-C30, even more preferentially C10-C24;
Y is selected from: —(O—CH2-CH2)-, —(O—CH(CH3)-CH2)- and —(O—CH2-CH2-CH2)-; and
preferably —(O—CH2-CH2)-;
n is an integer ranging from 1 to 60, preferably from 1 to 30, more preferentially from 1 to 20, better from 3 to 15, even better from 5 to 12.

6. The composition according to claim 1, characterised in that the surfactant or surfactants are present in a total proportion ranging from 5 to 10,000 ppm by weight, preferably from 50 to 5,000 ppm by weight, more preferentially from 100 to 2,500 ppm by weight and better still from 200 to 1,000 ppm by weight, with respect to the total weight of the composition.

7. The composition according claim 1, characterised in that the polydimethylsiloxane backbone of said copolymers comprises a mean number of dimethylsiloxane units lying in the range from 180 to 250.

8. The composition according to claim 1, characterised in that the polyoxyalkylene chains of said copolymers comply with the formula —(RO)m- with R designating one or more C1 to C4 alkylene groups and m a number lying in the range from 10 to 55, preferably the polyoxyalkylene chains are selected from polyoxyethylenes (EO), polyoxypropylenes (PO), and the chains formed by oxyethylene units and oxypropylene units (EO/PO), and more preferentially still from the chains formed by oxyethylene (OE) units and oxypropylene (OP) units with a ratio of the mean number of OE units to the mean number of OP units preferably lying in the range from 0.2 to 2, more preferentially from 0.3 to 1.3.

9. The composition according to claim 1, characterised in that the grafting rate of said copolymers lies in the range from 0.5% to 5%, preferably from 1% to 2%.

10. The composition according to claim 1, characterised in that said copolymer is cross-linked.

11. The composition according to claim 1, characterised in that the antifoaming additive or additives are present in a total proportion ranging from 1 to 200 ppm by weight, preferably from 2 to 100 ppm by weight, more preferentially from 3 to 50 ppm by weight, better from 4 to 25 ppm by weight and better still from 5 to 15 ppm by weight, with respect to the total weight of the composition.

12. The composition according to claim 1, characterised in that the water content thereof lies in the range from 50 to 90 by weight, preferably from 60 to 80 by weight, and better still from 65 to 70% by weight, with respect to the total weight of the composition.

13. A method for treating exhaust gases at the outlet of onboard or stationary internal combustion engines, characterised in that it includes at least one step of introducing a composition as defined in claim 1 into the flow of said exhaust gases.

14. A method for preventing or reducing deposits in the pipe that conveys the exhaust gases from the outlet of an internal combustion engine towards a device for the selective catalytic reduction of nitrogen oxides, characterised in that it includes at least one step of introducing a composition as defined in claim 1 into the flow of said exhaust gases.

15. A method for treating exhaust gases coming from an internal combustion engine, preferably a diesel engine, equipped with a device for selective catalytic reduction of nitrogen oxides, characterised in that it includes at least one step of introducing a composition as defined in claim 1 into the pipe that conveys the exhaust gases from the outlet of the engine to said selective catalytic reduction device.
